(19) United States
(12) Patent Application Publication
(10) Pub. No.: US 2026/0249397 A1
(43) Pub. Date: Aug. 27, 2026

(54) LASER-SUPPORTED DISASSEMBLING OF A BATTERY ARRANGEMENT

(71) Applicant: TRUMPF Laser- und Systemtechnik SE, Ditzingen (DE)

(72) Inventors: Max Rettenmeier, Jagstzell (DE); Oliver Müllerschön, Gerlingen (DE); Oliver Bocksrocker, Sachsenheim (DE); Mauritz Möller, Korntal (DE)

(21) Appl. No.: 19/649,174

(22) Filed: Apr. 16, 2026

Related U.S. Application Data
(63) Continuation of application No. PCT/EP2024/079145, filed on Oct. 16, 2024.

(30) Foreign Application Priority Data
Oct. 19, 2023 (DE) 10 2023 128 789.3

(51) Int. Cl. B23K 26/364; B23K 26/082; H01M 10/54

(52) U.S. Cl. CPC B23K 26/364; B23K 26/082; H01M 10/54

(57) ABSTRACT

A laser machining method for use during dismantling of a battery arrangement, wherein the battery arrangement has a cell arrangement and a battery housing enclosing the cell arrangement. The method includes directing a machining beam, which includes at least one laser beam, along a machining contour onto a surface of the battery housing facing away from the cell arrangement such that the battery housing is structurally weakened along at least one selected portion of the machining contour.

### CROSS REFERENCE TO RELATED APPLICATIONS

This application is a continuation of International Application No. PCT/EP2024/079145 (WO 2025/083025 A1), filed on October 16, 2024, and claims benefit to German Patent Application No. DE 10 2023 128 789.3, filed on October 19, 2023. The aforementioned applications are hereby incorporated by reference herein.

### FIELD

The present invention relates to the field of batteries, such as those used for operating electric motors in electric vehicles, and to a technique for opening a battery housing by means of laser cutting.

### BACKGROUND

The structure of battery arrangements, also known as battery packs, is described below in a simplified manner based on FIG. 1a. FIG. 1a shows a battery arrangement 10, in the interior of which a cell arrangement 12 having a plurality of cell modules 122 is arranged as a core component, which cell modules in turn comprise one or a plurality of electrically interconnected battery cells. The battery arrangement 10 comprises further functional components, such as a controller (also referred to as a BMS or battery management system), an interface to an electrical consumer, cooling elements, and others. The interior of the battery arrangement 10 is shielded from the outside by a battery housing 14, which in this case is made up of two housing shells 142, 144, which are firmly connected to each other along a laterally circumferential flange 146 (a connecting region) (e.g., by means of screws, rivets and/or by means of adhesive and/or welding connections).

In order for the components of a battery arrangement 10 to be reused in a resource-saving manner after the end of its life cycle, the battery arrangement 10 must be at least partially disassembled or dismantled. One of the first steps of disassembling or dismantling a battery arrangement 10 is to remove or at least open the housing 14 in order to access the core components of the battery arrangement 10 – in particular the battery cells contained in the cell arrangement 12, i.e., the valuable active material of the battery arrangement 10.

Thus far, the housing shells 142, 144 of housing 14 have usually been manually disassembled by a person. This manual process, which usually requires loosening a screw flange and/or adhesive bonds (and/or other connections such as rivet connections, weld connections, etc.) between the housing shells 142, 144, is very complex and requires that the battery cells inside the battery arrangement 10 are completely discharged in order to eliminate the risk of uncontrolled discharge (e.g., electric shock, short circuit, etc.) or thermal runaway of the battery cells during disassembly. Those skilled in the art also refer to this as deep discharge of the battery cells. The use of (partially) automated screwdriving technology or the use of machining processes to loosen or separate the joining connections between the housing shells 142, 144, which are usually made of aluminum or iron-based materials, contributes only marginally to an increase in efficiency in the disassembly of the battery arrangements.

### SUMMARY

In an embodiment, the present disclosure provides a laser machining method for use during dismantling of a battery arrangement, wherein the battery arrangement has a cell arrangement and a battery housing enclosing the cell arrangement, the method comprising directing a machining beam, which comprises at least one laser beam, along a machining contour onto a surface of the battery housing facing away from the cell arrangement such that the battery housing is structurally weakened along at least one selected portion of the machining contour.

### BRIEF DESCRIPTION OF THE DRAWINGS

Subject matter of the present disclosure will be described in even greater detail below based on the exemplary figures. All features described and/or illustrated herein can be used alone or combined in different combinations. The features and advantages of various embodiments will become apparent by reading the following detailed description with reference to the attached drawings, which illustrate the following:

FIG. 1a shows a schematic top view of a battery arrangement to illustrate a laser cutting method according to the present disclosure;

FIG. 1b shows a schematic sectional view of the battery arrangement according to FIG. 1a;

FIG. 2 shows a schematic representation of the creation of a cutting gap in a battery housing using a conventional laser cutting method; and

FIG. 3a, FIG. 3b, FIG. 3c, FIG. 3d and, FIG. 3e show schematic variants of a laser machining method according to the present disclosure.

### DETAILED DESCRIPTION

In an embodiment, the present disclosure improves on the prior art in relation to the disassembly of battery arrangements. In particular, it is made possible to open the housing of a battery arrangement flexibly and efficiently as part of an automated process, regardless of the condition and type of connection of the housing shells, without damaging the battery cells. Furthermore, contamination inside the battery arrangement can be avoided.

The foregoing advantages are achieved by the subject matter of the present disclosure specified in the description and the drawings.

According to an embodiment of the present disclosure, a laser machining method is provided for use during the dismantling of a battery arrangement. The battery arrangement comprises a cell arrangement and a battery housing enclosing the cell arrangement. The housing can, for example, be constructed from at least two housing shells, which are firmly connected to each other along an outer circumference of the housing (for example by a screw, rivet, adhesive and/or weld connection). In a simple design of the battery arrangement, the housing shells can also be referred to as half-shells. The battery arrangement can, for example, have a cell-to-pack battery pack architecture. This means that individual battery cells are installed (e.g., foamed) directly within a battery pack (i.e., a battery arrangement). Alternatively, the battery arrangement can also have a cell-to-module or module-to-pack architecture, in which a plurality of battery cells are packed into one cell module. If the battery arrangement comprises a plurality of cell modules, these are usually electrically connected to one another in order to combine the capacity of all battery cells. In addition to those mentioned, the battery arrangement can also have other pack architectures. For example, there are also cell-to-chassis architectures, in which the battery cells are directly integrated into the vehicle structure. In this case, the battery arrangement according to the present disclosure can be considered part of the vehicle and the battery housing as part of the vehicle structure. The housing or housing shells, or at least one of the housing shells, can be made of a metallic material, in particular aluminum-based (in particular 3000 series or 5000 series aluminum) or iron-based (in particular stainless steel). The thickness of a metallic housing shell can, for example, range from 0.5 mm to 3 mm. Alternatively, at least one of the housing shells can be made of a plastic or a fiber-reinforced composite material (CFRP). Preferably, the housing shells have the same or a similar material composition. Examples of battery arrangements according to the present disclosure comprise various (rechargeable) batteries from the field of e-mobility, for example for use in cars, trucks or commercial vehicles (BEV, PHEV, MHEV or HEV), forklifts, e-bikes, ships, aircraft, drones, etc., as well as in other areas, for example for building power supply or grid stabilization or in power tools (garden tools, cordless screwdrivers, etc.).

According to an embodiment of the present disclosure, a machining beam, which comprises at least one laser beam, is directed along a machining contour onto a surface of the battery housing facing away from the cell arrangement such that the battery housing is structurally weakened along at least one selected portion of the machining contour. In other words, the weakening of the housing structure leads to the creation of a predetermined breaking point in the battery housing along the relevant contour portion. The housing can be efficiently opened along the predetermined breaking point using a downstream opening method.

The laser machining method can preferably be carried out using a solid-state laser (in particular fiber lasers (such as, for example, from the applicant's TruFiber 500-2000 series) or disk lasers (such as, for example, from the TruDisk 2000-8000 series or TruDisk 3001-24001 series of the applicant)) as a single-mode laser or a multi-mode laser. The laser power can, for example, be in the range of 500 W to 24 kW, preferably in the range of 2 kW to 8 kW.

In a laser machining method according to the present disclosure, the battery housing is selectively weakened without laser radiation from the laser beam used penetrating into the interior of the battery arrangement. In a laser machining method according to the present disclosure, the battery housing is not cut open in the relevant contour portion, or at least not completely. Therefore, at least over part of the thickness of the battery housing, a layer of material remains that blocks the laser beam from entering the interior of the battery arrangement. Thus, the machining contour can also run along points where the optical axis of the processing laser beam intersects one or a plurality of battery cells or cell modules. In this way, the battery cells are protected from critical damage caused by laser radiation. At the same time, the housing is weakened to such an extent that it can be opened with minimal effort in a subsequent opening step.

The machining contour can extend in particular to one of the housing shells, for example to a first housing shell (i.e., in particular the upper shell). This way, a connection between a plurality of housing halves can be avoided when opening the housing.

The machining contour can also include contour portions in which the laser machining method is carried out as a laser cutting method (in particular as laser fusion cutting, laser flame cutting or laser sublimation methods) to create a cutting gap across the entire housing thickness. For these contour portions, it should be ensured that the optical axis of the laser beam does not cut through a battery module or battery cell. Furthermore, in such “safe” contour portions, contamination of the battery interior can also be uncritical for subsequent processing and recycling steps. It can be advantageous if, in this way, access points for opening the housing shell (e.g., by means of a gripper) are created, for example a recess or a gap that is directly adjacent to a predetermined breaking point.

It has been found that a laser machining method according to the present disclosure is suitable for disassembling battery arrangements. This is not a matter of course because laser cutting is a thermal machining method and the workpiece being machined is partially heated to very high temperatures. In contrast, for the battery cells of a battery arrangement, a heat input of 60°C, no more than 100°C can be critical (risk of ignition). It has been shown that laser machining, due to its flexible applicability and high degree of automation, can significantly simplify the process during the dismantling of battery arrangements. Firstly, the speed of disassembly is significantly increased compared to a manual process. Furthermore, by selectively separating only one housing shell, the process can be carried out regardless of the type and/or nature of the connection between the housing shells (welded connection, screwed connection, riveted connection, adhesive connection, etc.) and offers great flexibility. When using a (numerically controlled) laser machining method according to the present disclosure, discharging the battery cells is generally not necessary, since the high precision of the method makes it highly likely that critical damage or interference with the battery cells inside the battery arrangement, which could lead to uncontrolled discharge or thermal runaway, can be excluded. The laser cutting method takes place in a safe environment and is preferably fully automated. This also reduces the risk of personal injury during the disassembly of the battery arrangements.

According to an embodiment, the laser machining method is a laser cutting method, in which the laser beam together with a cutting gas jet is directed along the machining contour onto the surface of the battery housing facing away from the cell arrangement. The laser cutting method is preferably set such that a cutting gap created along the machining contour extends only over a part of the thickness of the battery housing. The molten material or slag produced during this laser cutting method is blown upwards out of the cutting gap by the cutting gas jet (since the cutting gap is not open at the bottom). The cutting depth (i.e., the depth of the cutting gap) is preferably at least 0.1*d, more preferably at least 0.3*d, more preferably at least 0.5*d and preferably at most 0.9*d, more preferably at most 0.8*d, more preferably at most 0.7*d, where “d” is the thickness of the housing or the housing wall at the corresponding location. In this case, the cutting gap can also be called a notch, since it is closed at the bottom. In particular, an inert cutting gas, such as nitrogen, can be used for the laser cutting method. Furthermore, the use of an inert cutting gas can prevent the risk of ignition of surrounding plastic parts (e.g., foams or plastic components) on or inside the battery arrangement. Especially with a comparatively thick metal housing, oxygen or an oxygen-containing gas mixture can also be used as the cutting gas, and the laser cutting method can thus be implemented as a laser flame cutting process.

When the laser machining method is carried out as a laser melting or laser flame cutting method, the laser cutting method is performed using a laser cutting system, preferably with fixed optics, by means of which the laser beam is directed onto the housing together with the cutting gas jet via a cutting nozzle (i.e., coaxially). Furthermore, a laser beam can be used to carry out the method, which has a central core beam and a ring-shaped beam enclosing the core beam. This beam shape can be implemented using the well-known 2-in-1 technology, in which the laser beam is guided into the processing optics via a 2-in-1 optical fiber, enabling both an increase in cutting speed and an improvement in the cut edges.

For example, a cutting nozzle can be a nozzle where the inner contour has the shape of a Laval nozzle. Using a Laval nozzle as a cutting nozzle can achieve comparatively larger working distances with comparatively lower cutting gas consumption.

According to one variant, the cutting gas can also be supplied to the weld pool generated by the laser beam during the cutting process at an angle of less than 90°. The angle of incidence of the cutting gas relative to the housing surface (with preferably perpendicular incidence of the laser beam) can preferably be between 75° and 15°, more preferably between 60° and 30°. The melt produced by the laser beam can therefore be blown out of the cutting gap from the side. This means, for example, that the cutting head can be better protected from splashes. Contamination from melt splashes can also be better controlled in general by deflecting all splashes in one direction.

Alternatively or additionally, a variant is also provided in which the splashes are extracted by a suction device.

As an alternative to the laser cutting methods described above, the cutting gap can extend over the entire thickness (i.e., the material thickness) of the battery housing, provided that the cutting parameters are set so that the cutting slag accumulates at the bottom of the cutting gap and closes the cutting gap at the bottom, so that the laser beam does not shine through the cutting gap on the underside of the battery housing. Such an incomplete cutting gap can be generated, for example, by increasing the cutting speed (feed rate) compared to a conventional laser cutting method, in which the cutting slag (i.e., the melt expelled during cutting) is completely expelled from the cutting gap, and by increasing it to such an extent that the desired incomplete cutting gap is formed.

According to an embodiment, the laser machining method can be implemented as a laser cutting method, which is set such that a cutting gap created along the machining contour extends only over a part of the thickness of the battery housing, wherein the melt produced by the laser beam during laser cutting is at least partially deposited on the upper face of the battery housing, laterally next to the cutting gap, by weld pool formation and allowed to solidify. Weld pool formation can be supported, for example, electromagnetically and/or pneumatically. This method differs from the laser cutting methods described above in that the melt is removed in a more controlled manner, thus preventing uncontrolled contamination of the processing device and/or the battery housing.

According to an embodiment, the laser machining method can be carried out as a laser sublimation process, in which the material of the battery housing is at least partially vaporized along the machining contour by means of the laser beam. Furthermore, the laser sublimation process is set such that a cutting gap created along the machining contour only extends over a part of the thickness of the battery housing. The depth of the cutting gap or the produced notch can also preferably be in the range of 0.1*d to 0.9*d, more preferably from 0.3*d to 0.8*d, and even more preferably in the range of 0.5*d to 0.7*d in this method variant. Any melt that may be produced during laser sublimation cutting is driven upwards out of the cutting gap by the vapor pressure generated in the cutting gap. In laser sublimation cutting, pulsed laser radiation is preferably used to achieve the intensities required to vaporize the housing material.

According to an embodiment, the material of the battery housing is heated along the machining contour by means of the laser beam such that the material undergoes a change in structure over at least part of its thickness, which causes a structural weakening of the housing wall in the irradiated region. This variant preferably does not create a gap or notch in the housing. Instead, the housing material is structurally weakened along the machining contour over at least part of the housing thickness, for example by targeted embrittlement of the material (e.g., due to brief heating and immediately subsequent rapid cooling). In this way, the housing can also be weakened in a targeted manner along the machining contour, so that it can be opened efficiently in a subsequent opening step (e.g., by means of a mechanical process).

A laser machining method according to the present disclosure can further comprise optical observation of the laser machining method to detect an actual progression of the generated modification on the housing. Furthermore, the method can include readjusting the processing parameters of the laser machining method if the course of the modification produced deviates from the specified machining contour by at least a specified minimum value, in order to bring the modification trajectory and the specified machining contour into alignment. By compensating for the determined tolerances, the precision of the machining method can be increased. Waste can consequently be reduced.

Furthermore, the laser machining method implemented as a laser cutting method can include the following steps: measuring, during the laser cutting method, a distance between a cutting nozzle used for the laser cutting method and the surface of the first housing shell; and adapting the preset cutting parameters of the cutting process based on the measured distance. By measuring and, if necessary, adapting the working distance of the cutting nozzle (e.g., capacitively, using an OCT measuring method or by means of laser triangulation), the contour accuracy and thus the precision in laser cutting can be increased.

Further features of a laser machining method according to the present disclosure can include:
pretreatment (e.g., cleaning, pre-cooling, pre-heating, etc.) of the housing shell to be processed in order to enhance the desired effects in the subsequent laser machining method and/or to increase process reliability;
active control of the weld pool (especially height profile measurement) e.g., by OCT (efficient and precise cutting process enables targeted generation of a predetermined breaking point);
targeted introduction of additives to generate or maintain the predetermined breaking point.

According to the present disclosure, a method for opening a battery housing is further provided, wherein the battery housing contains a cell arrangement of a battery arrangement. In a first step, the method comprises a targeted weakening of the structure of the battery housing along a predetermined machining contour by means of a laser machining method according to any one of the variants described above. In a second step, the method comprises mechanical separation of an opening portion of the battery housing along the machining contour from an enclosing residual portion of the battery housing. The mechanical separation of the opening portion from the remaining portion can be achieved, for example, by means of an opening device that grips the housing in the opening portion, for example by means of one or a plurality of suction cups, magnets, grippers, or similar devices, and that pulls the opening portion upwards from the enclosing housing (remaining portion) along the predetermined breaking point, as when opening a tin can. According to another variant, the opening portion can also be pressed downwards into the interior of the battery arrangement, for example using a vibrating hammer, in order to detach it from the enclosing residual area and then remove it.

According to the present disclosure, a laser processing device for processing the housing of a battery arrangement is also provided. The device comprises at least: a workpiece support for supporting the battery arrangement during the laser machining method; a laser beam source for providing a laser beam; a laser processing head for focusing the laser beam in the direction of the battery housing; and a control unit designed to actuate the device to carry out a laser machining method according to one of the variants described above. If the laser machining method is implemented as a laser fusion or laser flame cutting process, the device then further comprises at least one corresponding cutting gas supply. In particular, the device can be designed as a 3D laser cutting system, by means of which the processing head can be guided not only vertically (see 2D laser flatbed system), but also at an angle.

The following description of preferred exemplary embodiments serves to provide more detail in conjunction with the drawings.

Identical or functionally identical elements are provided with the same reference signs in the figures.

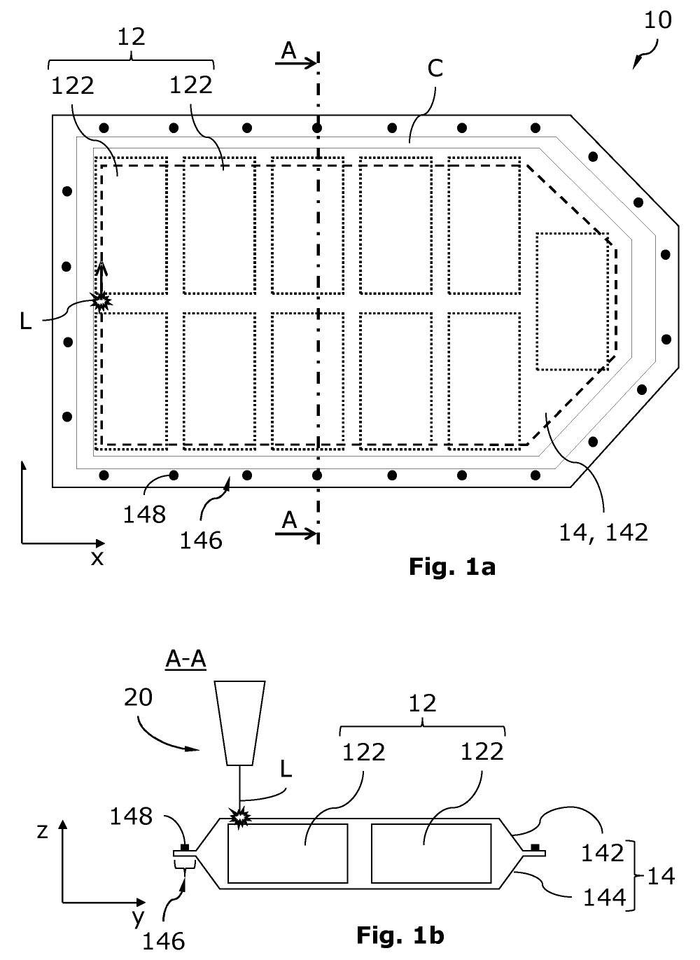

FIG. 1a shows a battery arrangement 10 in a top view, wherein the drawing plane in the top view corresponds to the x-y plane of a Cartesian coordinate system. The battery arrangement 10 has a cell arrangement 12 having a plurality of cell modules 122, which in turn house a plurality of battery cells. In other words, the depicted battery arrangement 10 has a cell-to-module or module-to-pack battery architecture. The cell arrangement 10, together with other battery components is surrounded by a housing 14. The housing 14 comprises a first housing shell 142 and a second housing shell 144, which are firmly connected to one another along a connecting region 146 on the outer circumference of the housing 14 – here by way of an example by means of a screw connection. It goes without saying that in addition to a screw connection, other connection types can also be provided, such as rivet connections, adhesive connections, welded connections, or combinations of a plurality of connection types. In the example shown, the first (in this case the upper) housing shell 142 is modified by means of a laser beam along a cutting contour C in order to selectively weaken the housing structure along the cutting contour C and to create a predetermined breaking point. As can be clearly seen in the top view, the cutting contour C (shown here as closed cutting contour C) extends in a plurality of contour portions directly above cell modules 122. Because the laser beam L does not penetrate into the interior of the housing during the laser machining method according to the present disclosure, the cell modules 122 are not damaged and the battery interior is not contaminated by the laser processing. The opening area (area within the closed contour line C) of the upper housing shell 142, separated by the predetermined breaking point, can then be pulled upwards, like a tin can, or otherwise removed, without having to loosen the screws 148 of the screw connection and without damaging or contaminating the interior of the battery arrangement 10.

FIG. 1b shows a cross-section through the battery arrangement 10 according to FIG. 1a along the sectional line A–A. It is also clearly visible in FIG. 1b that the optical axis of the laser beam L intersects a cell module 122. FIG. 1b shows a highly schematic representation of a laser processing head 20 of a laser processing machine or system, by means of which the laser beam L, with or without a cutting gas jet, is directed onto the first housing shell 142 of the battery housing 14.

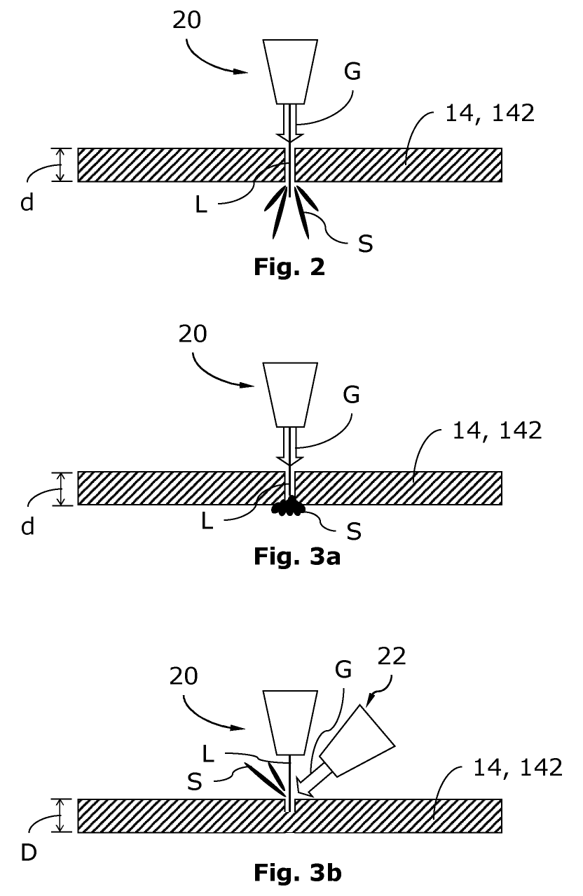

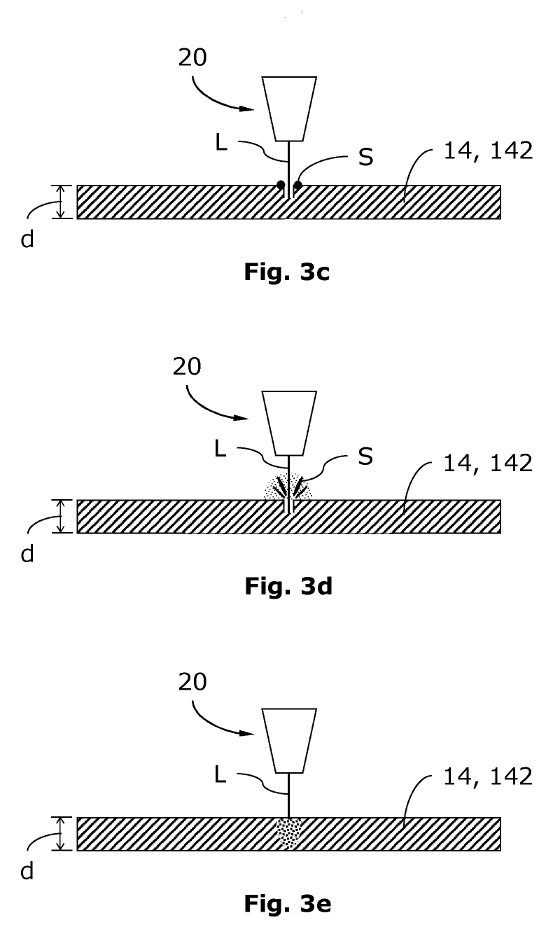

FIG. 2 schematically shows a conventional laser cutting method with which a cutting gap can be created in the housing 14 of a battery arrangement 10. A feed direction of the machining beam, consisting of laser beam L and cutting gas jet G, (or the machining contour C) extends perpendicular to the drawing plane (as also in the following FIGS. 3a-e). According to FIG. 2, the material of the housing 14 or the first (upper) housing shell 142 is melted by means of the laser beam L and the resulting melt S is blown downwards out of the resulting cut joint by means of the cutting gas jet G. The resulting cutting gap therefore extends over the entire thickness d of the depicted portion of the housing wall. When applying the laser cutting method described above for cutting a battery housing 14 in accordance with the present disclosure, it should be noted that the downwardly exiting cutting slag (or melt) S penetrates the interior of the battery arrangement and contaminates it. Furthermore, the laser beam L enters the interior of the battery arrangement and can damage or destroy components inside the battery arrangement. Analogous to the laser cutting method according to FIG. 2, for non-critical contour portions of the machining contour C, for example a laser sublimation process can also be used, in which a cutting gap is created over the entire workpiece thickness (i.e., housing thickness). In this way, contamination of the housing interior can be reduced compared to the conventional laser cutting method (see FIG. 2).

FIGS. 3a-e each show highly schematic variants of a machining process according to the present disclosure for use during the dismantling of a battery arrangement 10.

FIG. 3a shows a variant in which the laser machining method is implemented as a laser cutting method in which a cut extends over the entire thickness d of the housing wall, wherein the process parameters (in particular the feed rate and/or the laser power) are set so that the melt S generated during cutting cannot be completely driven out of the cutting gap and accumulates and solidifies at the lower end of the cutting gap. In this way, the cutting gap is closed at the bottom and the laser beam L cannot radiate downwards into the interior of the battery arrangement 10.

FIG. 3b shows a laser cutting method in which a laser beam L melts the material of the housing 14 to a predetermined depth, the depth being less than the thickness d of the housing wall. According to this method variant, the cutting gas G is blasted onto the processing area via a cross-blowing nozzle 22 (also called a “sidejet”) at an angle to the surface of the housing 14, so that the melt S generated by the laser beam L is blown out in a predetermined direction (here left) forming the cutting gap or notch. It is understood that, analogous to the method variant shown in FIG. 3b, the cutting gas G can also be directed coaxially to the laser beam L via the common nozzle 20 onto the housing surface. In this case, the melt S is expelled upwards from the cutting gap on both sides.

According to the method variant shown in FIG. 3c, the melt produced by the laser beam L is deposited on the housing surface along the resulting cutting gap or notch by weld pool formation.

FIG. 3d schematically illustrates a laser sublimation cutting process in which the cutting gap or notch is generated by the, preferably pulsed, laser beam L. Here, the material is selectively vaporized and, if necessary, partially melted by the laser beam L. Any melt S that may form is driven upwards out of the cutting gap or notch by the vapor pressure prevailing in the cutting gap.

Finally, FIG. 3e shows a variant of the process in which the material of the housing 14 or the first housing shell 142 is structurally modified by the laser beam L (and/or by additionally introduced additives) without creating a cutting gap or a notch. In this way, the material of the housing 14 can also be significantly weakened along the machining contour C, creating a predetermined breaking point.

The following list contains further features and processing parameters, as well a those previously mentioned, that can be relevant for a laser cutting method according to the present disclosure for cutting open a battery housing 14 of a battery arrangement 10:
the first housing shell 142, preferably both housing shells 142, 144, consist of a sheet material with a thickness in the range of 0.5 mm to 3 mm, in particular based on aluminum (3000 series or 5000 series aluminum) or on iron (in particular stainless steel);
a single-mode laser (e.g., from the applicant's TruFiber 500-2000 series) or a multi-mode laser (e.g., from the TruDisk 2000-8000 or 3001-24001 series) is used as the laser beam source for the laser machining method, preferably having a laser power in the range of 2 kW to 8 kW;
a fixed optic can preferably be used to carry out the laser machining method implemented as a laser cutting method, which is moved over the workpiece (i.e., the first housing shell 142), with the use of cutting gas (conventional laser cutting), with a cutting nozzle and preferably using inert cutting gas to expel the melt;
for other applications (e.g., laser sublimation cutting or irradiation without material removal), a scanner optic can also be used for remote laser processing;
the laser beam L used for the laser machining method can have a beam parameter product in the range of 0.38 mm*mrad to 16 mm*mrad, in particular of at most 0.6 mm*mrad (single-mode) or of at most 6 mm*mrad (multi-mode), preferably of 4 mm*mrad;
the beam diameter L of the laser beam on the workpiece (i.e., on the surface of the first housing shell 142) can be in the range of 50 µm to 500 µm, in particular in the range of 30 µm to 70 µm (single-mode) and/or (single spot or n-in-1) in the range of 100 µm to 300 µm (multi-mode);
an infrared laser with a wavelength in the range of 800 nm to 1200 nm, in particular with a wavelength of 1030 nm or 1070 nm, can preferably be used as the laser for the laser machining method;
alternatively, a VIS laser can also be used for the laser machining method, in particular having a wavelength of 515 nm (green spectral range);
the laser power used for laser machining method can range from 0.5 kW to 24 kW, particularly from 2 kW to 8 kW;
the feed rate of the laser machining method can be in the range of 1 m/min to 80 m/min (depending on the material thickness), in particular in the range of at least 5 m/min or at least 10 m/min or at least 20 m/min up to a maximum of 60 m/min;
as a laser cutting method, a cutting optic having a cutting nozzle and cutting gas and having an imaging ratio of 1:1 to 5:1, in particular of 1.5:1 to 2:1, can be used for the laser machining method;
alternatively, an optical scanner unit (for example, the applicant's scanner optic designated PFO33-2) having an imaging ratio of 1:1 to 5:1, in particular of 1.5:1 to 2:1, can be used;
a camera-based sensor (see the applicant's VisionLine product) can be used for position control during the laser machining method;
the surface of the housing 14 to be processed can be prepared for the cutting process, for example by appropriate cleaning processes (e.g., laser cleaning; grinding or other mechanical cleaning; chemical cleaning; etc.). This enables surface contaminants to be removed before the laser machining method, thus increasing the process reliability of the cutting process.

While subject matter of the present disclosure has been illustrated and described in detail in the drawings and foregoing description, such illustration and description are to be considered illustrative or exemplary and not restrictive. Any statement made herein characterizing the invention is also to be considered illustrative or exemplary and not restrictive as the invention is defined by the claims. It will be understood that changes and modifications may be made, by those of ordinary skill in the art, within the scope of the following claims, which may include any combination of features from different embodiments described above.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

1. A laser machining method for use during dismantling of a battery arrangement, wherein the battery arrangement has a cell arrangement and a battery housing enclosing the cell arrangement, the method comprising:
directing a machining beam, which comprises at least one laser beam, along a machining contour onto a surface of the battery housing facing away from the cell arrangement such that the battery housing is structurally weakened along at least one selected portion of the machining contour.

2. The laser machining method according to claim 1, wherein the laser machining method is a laser cutting method and the laser machining method further comprises directing the at least one laser beam together with a cutting gas jet along the machining contour onto the surface of the battery housing facing away from the cell arrangement, and
wherein the laser cutting method is set such that a cutting gap created along the machining contour extends only over a part of a thickness of the battery housing.

3. The laser machining method according to claim 2, wherein the cutting gas jet is supplied to the weld pool generated by the laser beam during the cutting process at an angle of less than 90°.

4. The laser machining method according to claim 1, wherein the laser machining method is a laser cutting method,
wherein the laser cutting method is set such that a cutting gap created along the machining contour extends only over a part of a thickness of the battery housing, and
wherein melt produced by the at least one laser beam during laser cutting is at least partially deposited on the upper face of the battery housing, laterally next to the cutting gap, by weld pool formation and allowed to solidify.

5. The laser machining method according to claim 1, wherein the laser machining method is a laser sublimation method, and the laser machining method further comprises at least partially vaporizing material of the battery housing along the machining contour with the at least one laser beam, and
wherein the laser sublimation process is set such that a cutting gap created along the machining contour extends only over a part of a thickness of the battery housing.

6. The laser machining method according to claim 1, wherein material of the battery housing is heated along the machining contour by the at least one laser beam such that the material undergoes a change in structure over at least part of its thickness, the change in structure causing a structural weakening of the housing wall in an irradiated region.

7. A method for opening a battery housing containing a cell arrangement of a battery arrangement, the method comprising:
targeted weakening of a structure of the battery housing along a predetermined machining contour by the laser machining method according to claim 1; and
mechanically separating an opening portion of the battery housing along the machining contour from an enclosing residual portion of the battery housing.

8. A laser processing device for processing the housing of a battery arrangement, the device comprising at least:
a workpiece support for supporting the battery arrangement during a laser cutting process;
a laser beam source for providing a laser beam;
a laser processing head for focusing the laser beam towards the battery housing; and
a controller configured to control the laser processing device to carry out the laser machining method according to claim 1.
